(19) United States
(12) Patent Application Publication
(10) Pub. No.: US 2015/0172589 A1
(43) Pub. Date: Jun. 18, 2015

(54) ELECTRONIC DEVICE AND METHOD FOR CONTROLLING THE SAME

(71) Applicant: Kabushiki Kaisha Toshiba, Tokyo (JP)

(72) Inventors: Yu Onodera, Kumagaya-shi (JP); Kohei Miyoshi, Kumagaya-shi (JP)

(73) Assignee: Kabushiki Kaisha Toshiba, Tokyo (JP)

(21) Appl. No.: 14/257,358

(22) Filed: Apr. 21, 2014

Related U.S. Application Data
(60) Provisional application No. 61/916,453, filed on Dec. 16, 2013.

(51) Int. Cl. H04N 5/63

(52) U.S. Cl. CPC H04N 5/63

(57) ABSTRACT

The electronic device comprises a connection module to which the source device is connected via a cable conforming to a predetermined standard, and a condition determining and energy saving module configured to save energy used inside the device when a state of a signal output from the source device is a predetermined condition. And a switching module is configured to vary an upper limit of a charging current supplied to a power supply line of the cable to a current value which exceeds a normal value and to perform high-speed charging of the source device when energy is saved.

### CROSS-REFERENCE TO RELATED APPLICATIONS

This application claims the benefit of U.S. Provisional Application No. 61/916,453, filed Dec. 16, 2013, the entire contents of which are incorporated herein by reference.

### FIELD

Embodiments described herein relate generally to an electronic device and a method for controlling the same.

### BACKGROUND

Electronic devices capable of recording and reproducing video contents (data stream) such as movies, TV programs, games, etc., have generally become widespread.

On the other hand, the High Definition Multimedia Interface (HDMI) (registered trademark), the Mobile High-definition Link (MHL) (registered trademark), etc., can be cited as standards for transmitting a data stream. A cable (which may be called USB cable) conforming to the above standards is used when an electronic device transmits a data stream to the other electronic device and receives a data stream from the other electronic device.

The electronic device which outputs a data stream may be called a source device and the electronic device which receives the stream may be called a sink device. The sink device reproduces the received stream and displays the reproduced video on a display.

When the source device and the sink device are connected to each other via a USB cable, the devices can mutually operate and control each other. In addition, the sink device can supply the power to the source device via the USB cable.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a diagram showing a typical example of a situation in which a television receiver and a mobile terminal are connected via a USB cable according to an embodiment;

FIG. 2A is a diagram illustrating an example of operations of the television receiver and the mobile terminal according to the embodiment;

FIG. 2B is a diagram illustrating another example of operations of the television receiver and the mobile terminal according to the embodiment;

FIG. 2C is a diagram illustrating yet another example of operations of the television receiver and the mobile terminal according to the embodiment;

FIG. 2D is a diagram illustrating yet another example of operations of the television receiver and the mobile terminal according to the embodiment;

FIG. 3 is a typical flowchart showing an example of operations of a controller inside the television receiver according to the embodiment;

FIG. 4 is a diagram showing a typical example of a structure of the television receiver according to the embodiment;

FIG. 5 is a diagram showing a typical example of a structure of a communication system based on the MHL standard constructed between the television receiver and the mobile terminal;

FIG. 6 is a typical diagram showing an example of a structure of the mobile terminal according to the embodiment; and

FIG. 7 is a schematic diagram of a charging system to supply power from the television receiver to the mobile terminal.

### DETAILED DESCRIPTION

Various embodiments will be described hereinafter with reference to the accompanying drawings. In general, one embodiment aims to provide an electronic device capable of performing high-speed charging of a source device in accordance with various conditions of the source device and a sink device, and a method for controlling the electronic device.

In general, according to one embodiment, an electronic device comprising: a connection controller configure to connect to a source device via a cable conforming to a first standard; a condition determining and energy saving controller configured to decrease the energy used by the electronic device when a state of a signal output from the source device comprises a first condition; and a switching controller configured to vary an upper limit of a charging current supplied to a power supply line of the cable to a value which exceeds a normal value and to perform high-speed charging of the source device when energy usage is decreased.

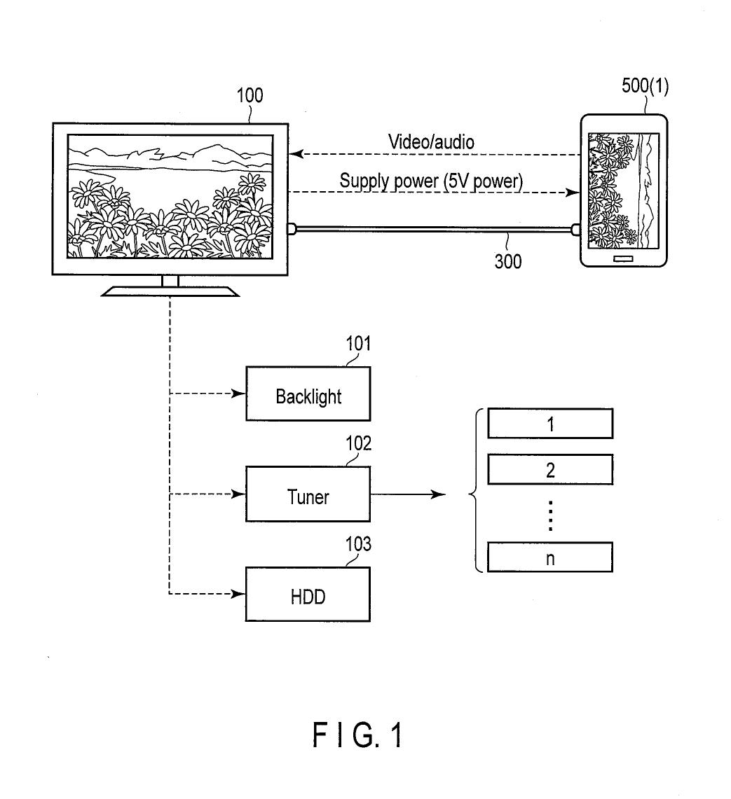

An electronic device and a method for controlling the same according to an embodiment will be specifically described hereinafter with reference to the accompanying drawings. FIG. 1 shows a situation in which a television receiver (which may be called a sink device) 100 and a mobile terminal (which may be called a source device) 500(1) such as a smartphone are connected via a USB cable 300 conforming to the HDMI and MHL standards.

The television receiver 100 can supply the power to the mobile terminal 500(1) via a predetermined line in the USB cable 300. This power supply state is called a charging state. The mobile terminal 500(1) can provide the television receiver 100 with contents such as video and audio.

In FIG. 1, video played back on the mobile terminal 500(1) is also played back on the television receiver 100. In addition, the television receiver 100 supplies the power to the mobile terminal 500(1), and the mobile terminal 500(1) is in the charging state.

In general, a charging voltage and a charging current of the television receiver 100 are often limited to predetermined values (for example, 5 V and 500 mA). The reason is that distribution of the power to each block inside the television receiver 100 is planned, and the power distributed for charging is designed to be, for example, 500 mA at 5 V.

In the television receiver 100, a block which needs comparatively large power is, for example, a recording and reproducing device comprising a backlight 101, a tuner device 102 and a hard disk drive (HDD) 103. The tuner device comprises, for example, a plurality of digital tuners configured to simultaneously receive a plurality of channels.

The television receiver 100 according to the embodiment performs unprecedented and extraordinary operations for a charging operation when the mobile terminal 500(1) is connected to the television receiver 100 via the USB cable 300.

When the mobile terminal 500(1) is connected to the television receiver 100 via the USB cable 300, the television receiver 100 performs the following operations.

(1) The television receiver 100 determines whether video or audio data is input from the mobile terminal 500(1), and this determination corresponds to determination whether the mobile terminal 500(1) reproduces the video or not. Furthermore, this determination corresponds to determination whether a user uses the mobile terminal 500(1) or not.

(2) The television receiver 100 determines in what state the television receiver 100 is.

That is, the television receiver 100 determines whether the television receiver displays the video or not, whether all tuners (i.e., the tuner device) of the television receiver are in an operating state or not, which tuner stops and which tuner is operating, etc.

(3) The television receiver 100 can display a menu for setting whether to perform high-speed charging of the mobile terminal by the television receiver.

(4) The television receiver 100 can determine whether to perform high-speed charging of the mobile terminal by the television receiver in accordance with the setting. When the high-speed charging is not performed, the television receiver performs normal charging.

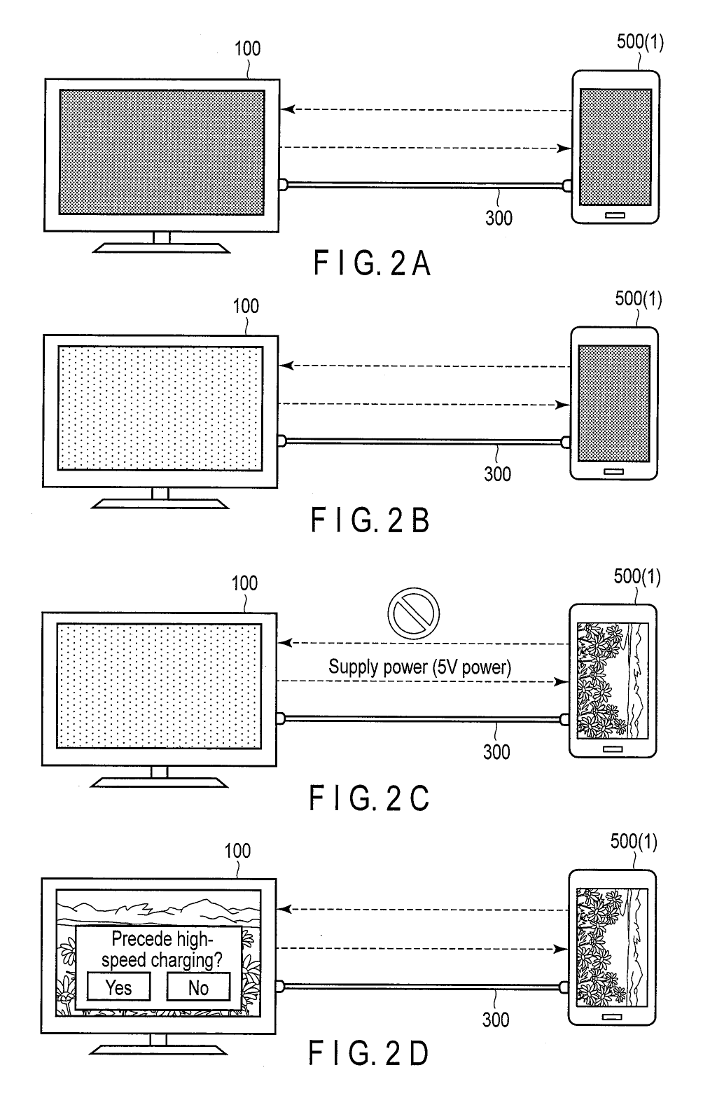

In FIG. 2A to FIG. 2D, the mobile terminal 500(1) is connected to the television receiver 100 via the USB cable 300.

In FIG. 2A, the mobile terminal 500(1) is not used and a screen of the mobile terminal 500(1) is darkened. At this time, even if a data stream for audio and video is transmitted, data of the stream is empty (black level or white level). Accordingly, the television receiver 100 determines that the mobile terminal 500(1) is not used. Another method can be used instead of this determination method. For example, a method of determining logical information of a control bus inside the USB cable may be adopted.

That is, it is determined whether a state of a signal output from the mobile terminal 500(1) (source device) is a predetermined state (or condition). The television receiver 100 comprises a state setting module, and if the state is the predetermined state, the state setting module saves the energy used inside the television receiver 100 as described below.

The state setting module in the television receiver 100 determines whether each block in the television receiver 100 is using the power.

FIG. 2A shows a case in which the television receiver 100 determines that the television receiver 100 is not used (reproduction is not performed). In this case, for example, the backlight is turned off. The tuner device may also be turned off. For this reason, allowance or redundancy of the power occurs inside the television receiver 100.

In this case, the television receiver 100 can be switched to a high-speed charging state for the mobile terminal 500(1). That is, a switching module varies a charging current supplied to a power supply line of the cable to a value which exceeds an upper limit of a normal value, and switches the current to perform high-speed charging of the mobile terminal 500(1). When the television receiver 100 determines that a battery of the mobile terminal 500(1) is fully charged, the television receiver 100 stops the charging operation.

If the tuner device is receiving a program and the program is being automatically recorded in the HDD, the backlight alone may be turned off.

Also in FIG. 2B, the mobile terminal 500(1) is not used and a screen of the mobile terminal 500(1) is dark.

Case (a) It is assumed that, for example, several tuners are operating in the television receiver 100 and a program is viewed on the television receiver 100. It is also assumed that a high-speed charging function is set or prepared.

The television receiver 100 saves the internal power to perform the high-speed charging. The surplus power produced by saving energy is used for the high-speed charging.

Inside the television receiver 100, for example, brightness of the backlight is decreased to save the power inside the television receiver 100. The user can confirm a program which is being automatically recorded when the brightness of the backlight is decreased.

Furthermore, if a program is not being recorded and the HDD is not used to further save the power, power supply to the HDD may be stopped. In addition, tuners which are not used may be powered off.

Case (b) It is assumed that the HDD is operating and a program is being automatically recorded in the television receiver 100. It is also assumed that the high-speed charging function is set.

The television receiver 100 saves the internal power to perform the high-speed charging. The surplus power produced by saving energy is used for the high-speed charging.

Inside the television receiver 100, for example, the brightness of the backlight is decreased to save the power. The high-speed charging of the mobile terminal 500(1) is implemented while the brightness of the television receiver 100 is decreased and the user is confirming a program which is being played back.

On the screen of the television receiver 100, for example, a comment “Currently automatically recording” alone may be displayed on the black background screen.

In FIG. 2C, the mobile terminal 500(1) is used and video is displayed on the screen of the mobile terminal 500(1).

In FIG. 2C, however, a stream for audio and video is not transmitted to the television receiver 100 since a predetermined operation is performed on the mobile terminal 500(1). In this state, a PATH_EN line of the USB cable becomes a low level. When the PATH_EN line of the USB cable becomes the low level, the television receiver 100 determines that video data is not input from the mobile terminal 500(1). Based on this determination, the television receiver 100 determines an operation situation inside the television receiver 100, and detects blocks (the backlight, the tuner, the HDD, etc.) which enable the power to be saved.

In FIG. 2C, the brightness of the backlight is decreased. The surplus power produced by decreasing the brightness of the backlight is used for the high-speed charging. The television receiver 100 is switched to the high-speed charging operation while saving the internal power. If the power can be further saved by powering off the other blocks, the brightness is decreased and the power is further saved.

As described above, the allowance or redundancy of the power is secured inside the television receiver 100. In this case, the television receiver 100 can be switched to the high-speed charging state for the mobile terminal 500(1). That is, the switching module varies the charging current supplied to the power supply line of the cable to a value which exceeds the upper limit of the normal value, and switches the current to perform the high-speed charging of the mobile terminal 500(1). When the television receiver 100 determines that the battery of the mobile terminal 500(1) is fully charged, the television receiver 100 stops the charging operation.

FIG. 2D shows that a message which asks the user whether to perform the high-speed charging or not when the mobile terminal 500(1) is connected to the television receiver 100. Along with the message “Do you precede high-speed charging?”, selection buttons “Yes” and “No” are displayed.

The menu may be displayed only in the case where the television receiver 100 determines an operation state of each internal block (the backlight, the tuner, the HDD, etc.) and the high-speed charging can be executed when the mobile terminal 500(1) is connected to the television receiver 100. Alternatively, the menu may be displayed when the television receiver 100 is initialized.

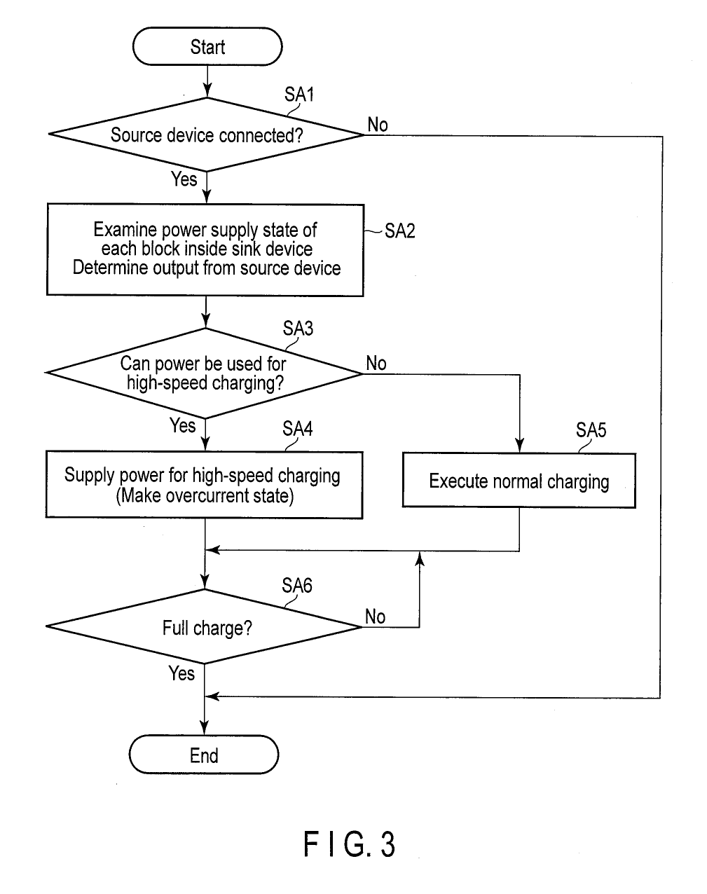

FIG. 3 is a typical flowchart showing an example of operations of a controller inside the television receiver 100. The controller determines whether the source device (the mobile terminal 500[1]) is connected or not (step SA1). The determination can be made by detecting a state of the control bus of the USB cable.

If it is determined that the mobile terminal 500(1) is connected, the controller determines whether a stream of video and audio is output from the mobile terminal 500(1) or not. In addition, the controller examines a power supply state of each block inside the sink device (the television receiver 100). In other words, the controller determines whether the power is supplied from a power supply device to each block and used (step SA2). The controller can thereby determine a block which should be powered off or save energy and can obtain the surplus power.

The controller determines whether the surplus power can be used for high-speed charging (step SA3). If the controller determines that the surplus power can be used for the high-speed charging, the controller sets a high-speed charging operation state (step SA4). If the controller determines that the high-speed charging cannot be performed, the controller sets a normal charging operation state (step SA5).

During charging, the controller determines whether the mobile terminal 500(1) is brought to a full charging state and, if the full charging state is confirmed, the controller ends the charging operation (step SA6).

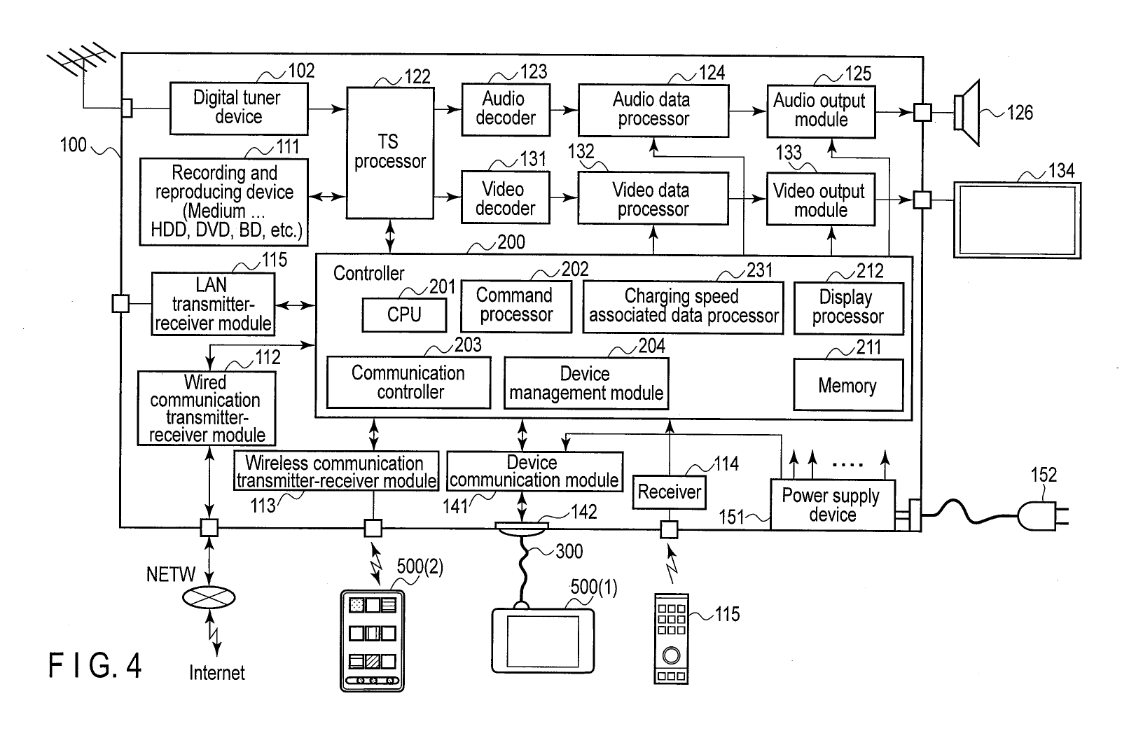

FIG. 4 schematically shows an example of a signal processing system of the television receiver 100. The television receiver 100 comprises a tuner device 102 including, for example, a plurality of tuners which receive scrambled digital terrestrial broadcast signals. The tuner device 102 may include, for example, a tuner (not shown) for receiving BS (broadcasting satellite)/CS (communication satellite) digital broadcast.

A signal of a broadcast program received by the tuner device 102 is input to a TS processor 122 such that transport streams (TSs) of a plurality of channels (CH) are re-multiplexed into a TS. The multiplexed TS includes a packet string of a broadcast program of each channel. Identification information for identifying a channel and a packet is added to a packet of each channel. The multiplexed TS is input to a recording and reproducing device 111. A packet including control information, of the TS input to the TS processor 122 is input to the controller 200 and processed.

The recording and reproducing device 111 includes, for example, a hard disk drive and/or an optical disk recording and reproducing device. As optical disks, a digital versatile disk (DVD) and/or a blu-ray disc (registered trademark) (BD) are adopted.

The packet transmitted from the TS processor 122 to the controller 200 includes, for example, information such as an entitlement control message (ECM) which is encrypted information on the broadcast program and an event information table (EIT) which is a table indicating event information such as program's name, performers, start time and the like, and electric program guide (EPG) information.

Video data included in the packet is encoded in, for example, the moving picture expert group (MPEG) format, the advanced video coding (AVC) format or the like. Audio data in an audio packet is encoded in, for example, the pulse code modulation (PCM) format, the Dolby format, the MPEG format or the like. The TS processor 122 separates a video packet of the program and the audio packet of the program.

Therefore, a packet including the audio data, of the packets separated in the TS processor 122 is input to an audio decoder 123 and decoded in accordance with the encoding format. The audio data decoded in the audio decoder 123 is subjected to synchronous processing, volume adjustment and the like in an audio data processor 124 and supplied to an audio output module 125. The audio output module 125 performs stereo separation processing according to a speaker system and supplies output to a speaker 126.

A packet including the video data, of the packet separated in the TS processor 122 is input to a video decoder 131 and decoded in accordance with the encoding format. The video data decoded in the video decoder 131 is subjected to synchronous processing, brightness adjustment, color adjustment and the like in a video data processor 132. Output of the video data processor 132 is supplied to a video output module 133. The video output module 133 can multiplex data, figures, a program table and the like from the controller 200 to a main image signal. In addition, the video output module 133 sets a scale, resolution, the number of lines, an aspect ratio and the like according to a display device 134 to the output video signal and output them to the display device 134.

Incidentally, an audio packet and a video packet of a pay program are often encrypted. In this case, a processing system to decrypt the packets by using key information is used, but the system is omitted here.

The controller 200 comprises a central processing unit (CPU) 201, an operation command processor 202, a communication controller 203, an operation device management module 204, a display processor 211 and a memory 212. The controller 200 further comprises an electric program guide (EPG) data processor, a memory controller, etc., which are not described here.

The CPU 201 controls an operation sequence of whole of the controller 200. The operation command processor 202 can analyze an operation command which is externally input and can reflect an operation according to the command on the television receiver 100.

The operation device management module 204 can hold and manage device identification data on the mobile terminals 500(1) and 500(2), a remote controller 115, etc. that provide an operation signal to the controller 200.

The display processor 211 can generally control the video signal displayed on the display device 134 via the video output module 133. The display processor 211 can also perform adjusting processing of resolution, a display size, a display area and the like of an image signal. In addition, the display processor 211 can supply to the video output module 133 a video signal of a program table generated by using EPG data and a menu video signal generated in the controller 200 in accordance with the operation signal. The memory 212 can store various types of data and applications to be stored in the controller 200.

The communication controller 203 can communicate with the outside and receive an operation command, data, contents, etc. The received contents and data can be stored in the recording and reproducing device 111 or the memory 212.

The communication controller 203 can transmit data, contents, etc. from the television receiver 100 to the outside. The communication controller 203 is connected to a wired communication transmitter-receiver module 112, a wireless communication transmitter-receiver module 113, a receiver 114 and a LAN transmitter-receiver module 115. In addition, the communication controller 203 can receive content data, control data, etc. from the outside via the wired communication transmitter-receiver module 112, the wireless communication transmitter-receiver module 113, the receiver 114 and the LAN transmitter-receiver module 115.

The wireless transmitter-receiver module 113 is a module for close-range communication and can execute data transmission to and data reception from a mobile terminal 500(2). The mobile terminal 500(2) can remotely control the television receiver 100. The mobile terminal 500(2) can access a server via a base station and the Internet (not shown). The mobile terminal 500(2) can download contents, various applications, game software, etc. from the server and transfer them to the controller 200 via the wireless communication transmitter-receiver module 113. The mobile terminal 500(2) can also transfer information (for example, an address of a web server, a mail address, a network address, etc.) for obtaining contents to the controller 200 via the wireless communication transmitter-receiver module 113.

When contents, applications or game software is transferred from the mobile terminal 500(2), the communication controller 203 operates. The communication controller 203 stores the received contents in the memory 212. The contents may be stored in the recording and reproducing device 111 in accordance with the operation command or automatically. The recording and reproducing device 111 can record the received contents in, for example, the hard disk. In the hard disk, the contents are managed as content files.

The communication controller 203 can also receive the operation signal from the remote controller 115 via the receiver 114.

The wired communication transmitter-receiver module 112 can execute data transmission to and data reception from a remote server via the Internet.

The menu video signal, a program table video signal for display, etc. are stored in or managed by the display processor 212. When the menu or the program table is displayed, menu screen data or the program table video signal is read from a data storage module (the memory or the hard disk) and supplied to the display processor 212 under control of a display controller 203. A menu video or a program table image is thereby displayed on the display device 134.

The menu video signal or the program table video signal for display can also be transmitted to the mobile terminal 500(1) or 500(2). If the mobile terminal 500(1) or 500(2) requests the menu video signal or the program table video signal, the display processor 212 can transmit the menu video signal or the program table video signal.

The mobile terminal 500(2) can display the menu video signal and the program table video signal on a touchpanel. The user can supply an operation command signal to the television receiver 100 by touching an operation button displayed on the touch (or point) panel. The LAN transmitter-receiver module 115 is connected to a domestic LAN.

The television receiver 100 further comprises a device communication module 141. The device communication module 141 can be connected to the mobile terminal 500(1) via a USB terminal 142 and the USB cable 300.

As regards processing of the data transmitted and received via the device communication module 141, the controller 200 comprises a charging speed associated data processor 231. The charging speed associated data processor 231 plays a central role in implementing the high-speed charging illustrated in FIG. 1 to FIG. 3. In addition, the charging speed associated data processor 231 can implement the menu display and the setting of the high-speed charging priority illustrated in FIG. 2C. Therefore, the charging speed associated data processor 231 can contain a menu processor configured to set whether or not to perform the high-speed charging operation.

When the mobile terminal 500(1) is charged via the device communication module 141 and the USB cable 300, power supply from the power supply device 151 is used. The power supply device 151 acquires an alternating current (AC) and an AC voltage from a commercial power source via a plug 152. The power supply device 151 rectifies the AC and the AC voltage, and generates and distributes power supplies suitable for each block (the backlight, each tuner of the tuner device, the recording and reproducing device, etc.)

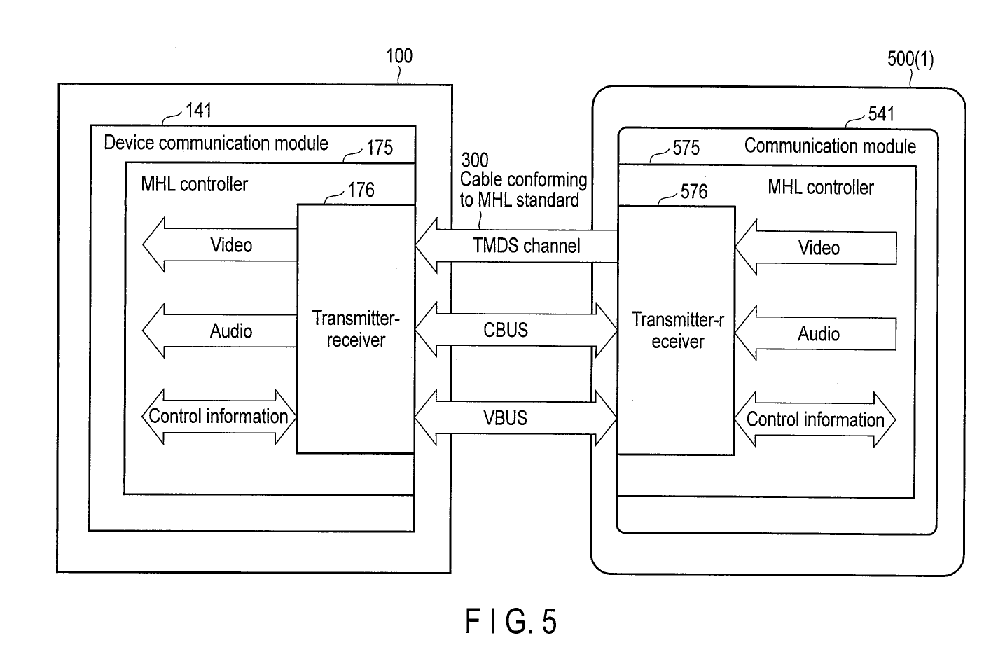

FIG. 5 shows an example of a communication system based on the MHL standard constructed between the television receiver 100 and the mobile terminal 500(1). It should be noted in the present embodiment that the mobile terminal 500(1) is the source device and the television receiver 100 is the sink device.

An MHL controller 575 of the mobile terminal 500(1) comprises a transmitter-receiver 576. An MHL controller 175 of the television receiver 100 also comprises a transmitter-receiver 176.

The transmitter-receivers 576 and 176 are connected by a cable 300 conforming to the MHL standard. The cable 300 comprises lines such as a VBUS, a GND, a CBUS, an MHL+, an MHL−, etc.

The VBUS is a line for transmitting the power. For example, the sink device supplies the power at +5V to the source device via the VBUS. The source device can operate by the power supplied from the sink device via the VBUS. For example, a power supply module of the mobile terminal 500(1) serving as the source device can charge the battery by using the power supplied from the sink device via the VBUS. The cable 300 also comprises a ground line GND (not shown).

The CBUS is a line for transmitting a control signal such as a command. The CBUS is used for, for example, bi-directionally transmitting a display data channel (DDC) command or an MHL sideband channel (MSC) command. The DDC command is used for reading of extended display identification data (EDID), high-bandwidth digital content protection (HDCP) authentication, etc. The EDID is a list of display information preset in accordance with specs on the display, etc. The MSC command is used for read/write of various registers (not shown), control using a remote control, etc.

For example, the television receiver 100 serving as the sink device outputs a command to the mobile terminal 500(1) serving as the source device via the CBUS. The mobile terminal 500(1) can perform various types of processing in accordance with the received command.

The source device can execute the HDCP authentication with the sink device and read the EDID from the sink device by transmitting the DDC command to the sink device.

The HDCP is a method of encrypting a signal transmitted between devices. The television receiver 100 and the mobile terminal 500(1) can transmit and receive a key, etc. by using the procedure conforming to the HDCP and execute mutual authentication.

The mobile terminal may be configured to acquire the EDID from the television receiver 100 not during the HDCP authentication, but in other timing.

The mobile terminal 500(1) analyzes the EDID acquired from the television receiver 100 and recognizes display information indicating a format of resolution, color depth, transmission frequency, etc. which can be processed by the television receiver 100. The mobile terminal 500(1) generates a stream in the format of resolution, color depth, transmission frequency, etc. which can be processed by the television receiver 100.

The MHL+ and the MHL− are lines for transmitting data. These two lines function as a twist pair. For example, the MHL+ and the MHL− functions as a transition minimized differential signaling (TMDS) channel configured to transmit data in the TMDS system. Furthermore, the MHL+ and the MHL− can transmit a synchronization signal (MHL clock) in the TMDS system.

For example, the source device can output a stream to the sink device via the TMDS channel. That is, the mobile terminal 500(1) serving as the source device can transmit a data stream prepared by converting images (display screen) displayed on the display and audio output from the speaker to the television receiver 100 serving as the sink device.

The television receiver 100 receives the data stream transmitted via the TMDS channel, executes signal processing for the received data stream and reproduces the processed data stream.

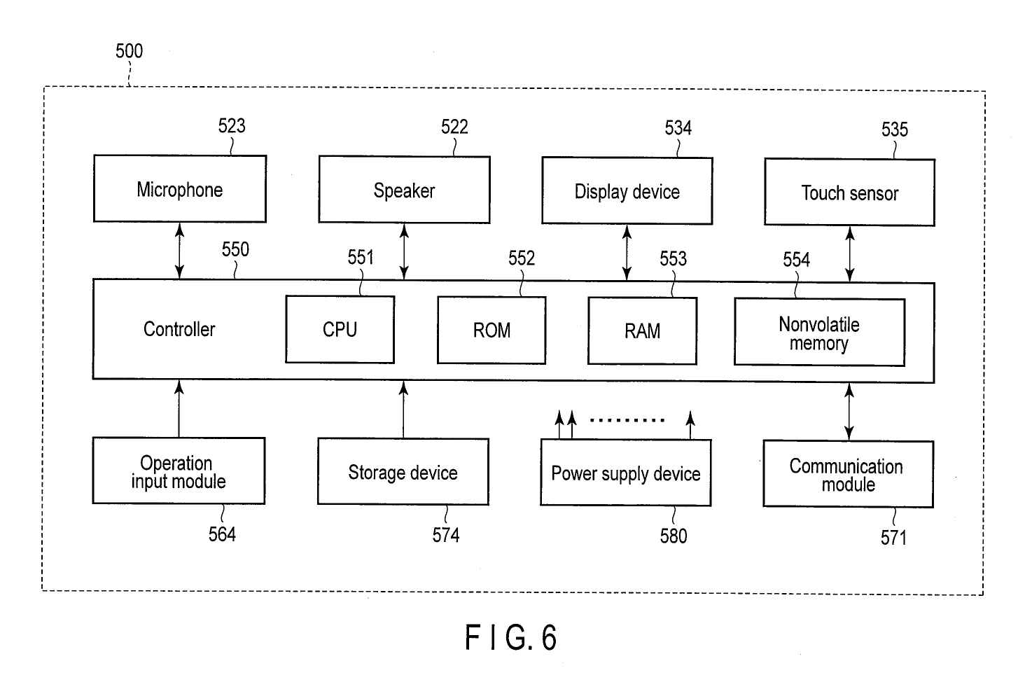

FIG. 6 shows an example of a structure of a mobile terminal 500(1) according to one of the embodiments. The mobile terminal 500(1) comprises a controller 550, an operation input module 564, a communication module 571 and a storage device 574. The mobile terminal 500(1) further comprises a speaker 522, a microphone 523, a display device 534 and a touch sensor 535. The display device 534 and the touch sensor 535 are integrated as one body.

The mobile terminal 500(1) further comprises a power supply device 580. The power supply device 580 can be equipped with a battery and a terminal (for example, a DC jack) to connect to an adapter configured to receive the power from a commercial power source, etc. The power supply device charges the battery by using the power received from the commercial power source. The power supply device further supplies the power supplied to the battery to each block inside the mobile terminal.

The controller 550 functions as a controller configured to control operations of each module of the mobile terminal 500(1). The controller 550 comprises a CPU 551, a ROM 552, a RAM 553, a nonvolatile memory 554, etc. The controller 550 performs various types of processing based on an operation signal from the operation input module 564 or the touch sensor 535.

The CPU 551 comprises an arithmetic element configured to perform various types of arithmetic processing, etc. The CPU 551 implements various functions by executing a program stored in the ROM 552, the nonvolatile memory 554 or the like.

The ROM 552 stores a program to control the mobile terminal 500(1), a program to implement various functions, etc. The CPU 551 activates a program stored in the ROM 552 based on an operation signal supplied from the operation input module 564. The controller 500 thereby controls operations of each module.

The RAM 553 functions as a working memory of the CPU 551. The nonvolatile memory 554 is a nonvolatile memory configured to store various types of configuration information, program, etc.

The CPU 551 can perform various types of processing based on data on applications, etc. stored in the storage device 574.

The controller 550 can generate video signals for display of various types of screens, etc. and display the signals on the display device 534 in accordance with an application executed by the CPU 551. The controller 550 can also generate audio signals for reproduction of various types of audio, etc. and output the signals from the speaker 522 in accordance with an application executed by the CPU 551.

The microphone 523 supplies a sound collection signal to the controller 550. The display device 534 is, for example, a liquid crystal display device and configured to display video based on the video signals.

The touch sensor 535 is a capacitance type sensor, a thermosensor or a device configured to generate positional information in the other manner.

The operation input module 564 comprises, for example, a key configured to generate an operation signal in accordance with the user's operation input. The operation input module 564 further comprises, for example, a volume adjustment key for adjusting a volume, a brightness adjustment key for adjusting display brightness of the display device 534, a power supply key for switching a power supply state of the mobile terminal 500(1), etc.

The communication module 571 includes an MHL controller 573 as illustrated in FIG. 4. The mobile terminal 500(1) can output a data stream to a device (sink device) connected to a USB terminal of the MHL controller 573.

The MHL controller 573 can also superimpose the video signals for display and the audio signals for reproduction and generate a data stream. The MHL controller 573 can generate a stream of various formats (for example, 1080i, 60 Hz) by using the video signals for display and the audio signals for reproduction.

The storage device 574 comprises a hard disk drive (HDD), a solid-state drive (SSD), a semiconductor memory, etc. The storage device 574 can store programs and applications executed by the CPU 551 of the controller 550, contents such as moving images, various types of data, etc.

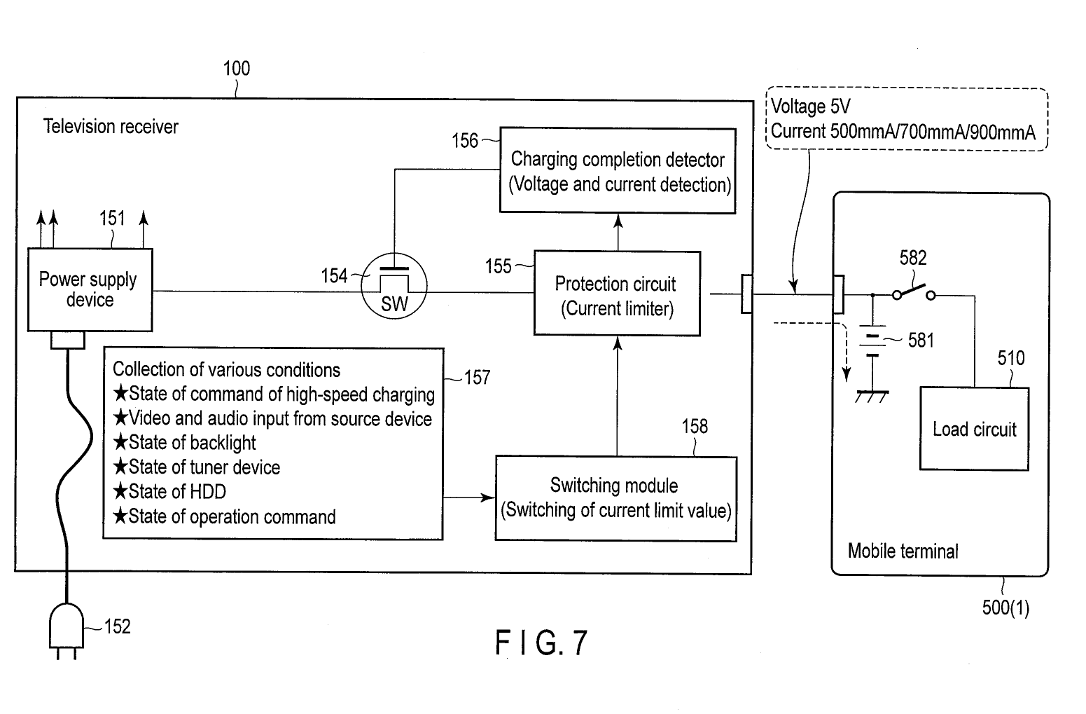

FIG. 7 is a schematic diagram showing a charging system of charging the mobile terminal 500(1) by the television receiver 100. The power supply device 151, a switch to supply the power to the mobile terminal 500(1), a protection circuit 155 and a charging completion detector 156 are provided in the television receiver 100. A condition determining and energy saving module 157 and a switching module 158 configured to switch a charging current value are further provided to implement the aforementioned high-speed charging.

A condition for enabling the high-speed charging to be performed is determined by the condition determining and energy saving module 157, and the power inside the receiver is saved. If the condition determining and energy saving module 157 determines that the high-speed charging can be performed, the switching module 158 switches an upper limit of the charging current in the protection circuit 155.

For example, the upper limit of the charging current is normally set to 500 mA. However, when the high-speed charging is performed, the current is set to, for example, 700 or 900 mA.

When charging is started, the charging completion detector 156 monitors variation in the voltage and the current. For example, when the high-speed charging is started, the voltage drastically varies from 0 to 5 V. The current also varies from 0 to 700 mA. However, the current gradually decreases in accordance with a progress status (status of capacity [SOC]) of the battery charging of the mobile terminal 500(1). The charging completion detector 156 determines the charging completion when the voltage is in this state (approximately 5V) and the current is lower than a predetermined value.

The charging completion detector 156 turns off the switch 154 when the charging completion is determined.

The battery (secondary battery) 581 of the mobile terminal 500(1) is connected to a load circuit 510 via a switch 582 when the battery is used. However, the switch 582 is turned off when the charging is performed (for example, when the battery is connected to the sink device via the USB cable). Then the battery 581 is in a charging standby state.

The various blocks of the embodiments described herein can be implemented as software applications, hardware and/or software modules, or components on one or more computers, such as servers. While the various blocks are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a connection controller configure to connect to a source device via a cable conforming to a first standard;
a condition determining and energy saving controller configured to decrease the energy used by the electronic device when a state of a signal output from the source device comprises a first condition; and
a switching controller configured to vary an upper limit of a charging current supplied to a power supply line of the cable to a value which exceeds a normal value and to perform high-speed charging of the source device when energy usage is decreased.

2. The device of claim 1, wherein the condition determining and energy saving controller is configured to determine that data on video and/or audio from the source device is not changed.

3. The device of claim 1, wherein the condition determining and energy saving controller is configured to turn off a backlight or to decrease brightness of the backlight to decrease energy usage.

4. The device of claim 1, wherein the condition determining and energy saving controller is configured to turn off a tuner device and/or a recording and reproducing device to decrease energy usage.

5. The device of claim 1, wherein the condition determining and energy saving controller is configure to decrease brightness of a backlight to decrease energy usage when video is displayed on a display device and watched.

6. The device of claim 1, further comprising a menu processing controller configured to determine whether to perform a high-speed charging operation.

7. The device of claim 1, wherein the cable conforming to the first standard conforms to the Mobile High-definition Link (registered trademark) standard.

8. The device of claim 1, wherein an upper limit of the normal value of the charging current output to the power supply line of the cable is 500 mA, and the current which exceeds the normal value is 700 mA.

9. A method for controlling an electronic device connected to a source device via a cable conforming to a first standard and configured to supply power to the source device, the method comprising:
saving energy used inside the electronic device when a state of a signal output from the source device comprises a first condition,
varying an upper limit of a charging current supplied to a power supply line of the cable to a value which exceeds a normal value, and
switching the charging current to perform high-speed charging of the source device when energy usage is decreased.

10. The method of claim 9, wherein the energy usage is decreased by one of or a combination of turning off a backlight, decreasing brightness of the backlight, turning off a tuner and turning off a hard disk drive.
